(19) United States
(12) Patent Application Publication
(10) Pub. No.: US 2025/0069122 A1
(43) Pub. Date: Feb. 27, 2025

(54) STORE INFORMATION DISPLAY SYSTEM, MOBILE TERMINAL, STORE INFORMATION DISPLAY METHOD, AND RECORDING MEDIUM

(71) Applicant: NEC Corporation, Minato-ku, Tokyo (JP)

(72) Inventors: Yuji TAHARA, Tokyo (JP); Rina Tomita, Tokyo (JP)

(73) Assignee: NEC Corporatio, Minato-ku, Tokyo (JP)

(21) Appl. No.: 18/724,699

(22) PCT Filed: Jan. 31, 2022
(86) PCT No.: PCT/JP2022/003490

§ 371 Date: Jun. 27, 2024

(51) Int. Cl. G06Q 30/02

(52) U.S. Cl. CPC G06Q 30/0281

(57) ABSTRACT

A store information display system comprising: at least one memory storing instructions; and at least one processor configured to execute the instructions to:
acquire, from a mobile terminal possessed by a user, identification information for identifying at least one of the user and the mobile terminal, and location information of the mobile terminal; identify a store visited by the user based on the location information, and associating the store, visit information regarding a visit to the store, and the identification information with each other; and output a store list generated based on the identification information and history information including the visit information.

### TECHNICAL FIELD

The present invention relates to a store information display system, a mobile terminal, a store information display method, and a recording medium.

### BACKGROUND ART

A system that displays store information regarding a store based on a user's operation is known.

As a technique related to the above-described system, PTL 1 discloses a technique in which a manager who goes around a plurality of affiliated stores can easily connect his/her own mobile terminal device to a network of each store.

In addition, PTL 2 discloses a technique of receiving a current position from a terminal device of a user and transmitting store information of a location satisfying a predetermined distance condition to the terminal device of the user.

### CITATION LIST

### Patent Literature

PTL 1: JP 2021-047539 A
PTL 2: JP 2015-032189 A

### SUMMARY OF INVENTION

### Technical Problem

In a case where a system for displaying store information regarding a store is used in a chain store or the like having a plurality of stores, a user needs to search for desired store information from a plurality of pieces of store information. However, it is complicated to search for the desired store information from the plurality of pieces of store information, and it is difficult to acquire the desired store information. Therefore, there is a demand for a system that enables a user to easily acquire desired store information.

Therefore, an object of the present invention is to provide a store information display system, a mobile terminal, a store information display method, and a recording medium that perform display capable of easily acquiring desired store information by identifying a store visited by a user from location information of a user terminal and outputting a store list generated based on history information including visit information of a visit to the identified store.

### Solution to Problem

A store information display system according to one aspect of the present invention includes: an information acquisition means for acquiring, from a mobile terminal possessed by a user, identification information for identifying at least one of the user and the mobile terminal, and location information of the mobile terminal; an information processing means for identifying a store visited by the user based on the location information, and associating the store, visit information regarding a visit to the store, and the identification information with each other; and an output means for outputting a store list generated based on the identification information and history information including the visit information.

A mobile terminal according to one aspect of the present invention is possessed by a user and includes: a location information acquisition means for acquiring location information: an information processing means for identifying a store visited by the user based on the location information, and associating the store with visit information regarding a visit to the store; and an output means for outputting a store list generated based on history information including the visit information.

A store information display method according to one aspect of the present invention includes: acquiring, from a mobile terminal possessed by a user, identification information for identifying at least one of the user and the mobile terminal, and location information of the mobile terminal: identifying a store visited by the user based on the location information: associating the store, visit information regarding a visit to the store, and the identification information with each other; and outputting a store list generated based on the identification information and history information including the visit information.

A recording medium according to one aspect of the present invention causes a computer to execute: acquiring, from a mobile terminal possessed by a user, identification information for identifying at least one of the user and the mobile terminal, and location information of the mobile terminal: identifying a store visited by the user based on the location information: associating the store, visit information regarding a visit to the store, and the identification information with each other; and outputting a store list generated based on the identification information and history information including the visit information.

### Advantageous Effects of Invention

According to the present invention, a user can more easily acquire desired store information.

### BRIEF DESCRIPTION OF DRAWINGS

FIG. 1 is a block diagram illustrating an example of a configuration of a store information display system according to a first example embodiment.

FIG. 2 is a flowchart illustrating an example of an operation of the store information display system to the first example embodiment.

FIG. 3 is a block diagram illustrating an example of a configuration of a store information display system according to a second example embodiment.

FIG. 4A illustrates an example of a store list based on visit dates and times.

FIG. 4B illustrates an example of a store list based on visit dates and times.

FIG. 5A illustrates an example of a store list based on visit frequencies.

FIG. 5B illustrates an example of a store list based on visit frequencies.

FIG. 6A illustrates an example of a store list based on visit frequencies and location information of stores.

FIG. 6B illustrates an example of a store list based on visit frequencies and location information of stores.

FIG. 7 illustrates an example of a store list based on visit frequencies and visit dates and times.

FIG. 8 illustrates an example of switchably displaying a plurality of store lists.

FIG. 9 is a data sheet illustrating an example of information stored in a storage means.

FIG. 10 is a block diagram illustrating an example of a configuration of a mobile terminal according to the second example embodiment.

FIG. 11 is a block diagram illustrating an example of a configuration of an output destination terminal according to the second example embodiment.

FIG. 12 is a sequence diagram illustrating an example of operations of the information display system, the mobile terminal, and the output destination terminal according to the second example embodiment.

FIG. 13 is a block diagram illustrating an example of a configuration of a store information display system according to a third example embodiment.

FIG. 14 is a block diagram illustrating an example of a configuration of a store information display system according to a fourth example embodiment.

FIG. 15 is a block diagram illustrating an example of a configuration of a mobile terminal according to a fifth example embodiment.

FIG. 16 is a flowchart illustrating an example of an operation of a store information display system to the fifth example embodiment.

FIG. 17 is a block diagram illustrating an example of a configuration of a store information display system according to a sixth example embodiment.

FIG. 18A illustrates an example of a store list in a case where a store A and a store E are priority stores.

FIG. 18B illustrates an example of a store list in a case where the store A and the store E are priority stores.

FIG. 19 is a diagram illustrating a configuration of a computer constituting the store information display system according to each example embodiment.

### EXAMPLE EMBODIMENTS

### First Example Embodiment

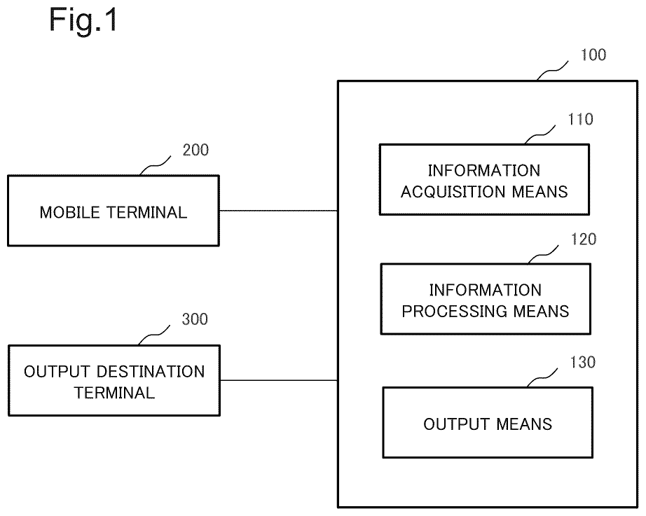

FIG. 1 illustrates an example of a configuration of a store information display system 100 according to a first example embodiment of the present invention. The store information display system 100 is communicably connected to a mobile terminal 200 and an output destination terminal 300. A plurality of mobile terminals 200 and a plurality of output destination terminals 300 may be provided. Further, the mobile terminal 200 and the output destination terminal 300 may be the same terminal, and a user of the mobile terminal 200 and a user of the output destination terminal 300 may be the same.

The store information display system 100 includes an information acquisition means 110, an information processing means 120, and an output means 130. In FIG. 1, each block included in the store information display system 100 indicates a configuration of a functional unit. Therefore, each block included in the store information display system 100 illustrated in FIG. 1 may be implemented in a single device, or may be separately implemented in a plurality of devices.

The information acquisition means 110 acquires identification information for identifying at least one of the user of the mobile terminal 200 and the mobile terminal 200, and location information of the mobile terminal 200 from the mobile terminal 200 possessed by the user.

The information processing means 120 identifies a store visited by the user of the mobile terminal 200 based on the location information of the mobile terminal 200. Then, the identified store, visit information regarding a visit to the identified store, and the identification information are associated with each other.

The output means 130 outputs a store list generated based on the identification information and history information including the visit information. Here, the history information is a set of visit information including at least one or more pieces of visit information.

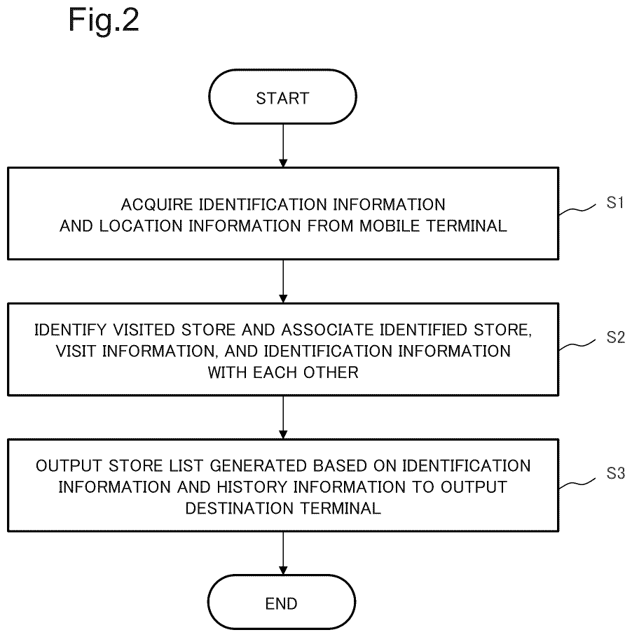

An operation of the store information display system according to the first example embodiment will be described with reference to the drawing. FIG. 2 is a flowchart illustrating an example of the operation of the store information display system according to the first example embodiment.

The information acquisition means 110 acquires the identification information and the location information from the mobile terminal 200 (step S1). Then, the information processing means 120 identifies a store visited by the user of the mobile terminal 200 based on the location information acquired by the information acquisition means 110, and associates the identified store, visit information regarding a visit to the identified store, and the identification information with each other (step S2). Steps S1 to S2 are repeatedly performed. The acquisition of the location information (step S1) may be always performed or may be performed at regular time intervals.

The output means 130 outputs, to the output destination terminal 300, a store list generated based on the identification information and history information including the visit information (step S3).

The store information display system according to the first example embodiment outputs a store list generated based on the identification information and history information including visit information of a store visited by the user of the mobile terminal 200. As a result, the system user can easily acquire desired store information.

### Second Example Embodiment

In a second example embodiment, a store information display system 1100 of the present invention will be described in more detail with reference to the drawings. The store information display system 1100 according to the second example embodiment is an example in which the store information display system 100 according to the first example embodiment further includes a storage means 140.

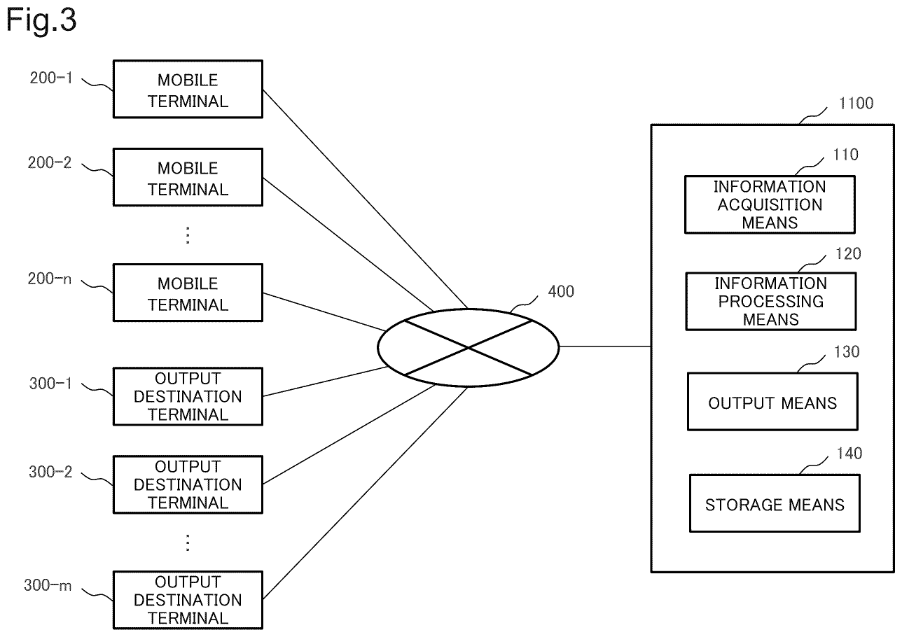

FIG. 3 illustrates an example of a configuration of the store information display system 1100 according to the second example embodiment of the present invention. The store information display system 1100 is communicably connected to the mobile terminal 200 and the output destination terminal 300 via a network 400. A plurality of mobile terminals 200 and a plurality of output destination terminals 300 may be provided. FIG. 3 illustrates an example of a configuration including n mobile terminals 200 (200-1, 200-2, - - - , and 200-n) and m output destination terminals 300 (300-1, 300-2, - - - , and 300-n). In addition, the mobile terminal 200 and the output destination terminal 300 may be the same terminal. The user of the mobile terminal 200 and the user of the output destination terminal 300 may be the same or different. Further, the store information display system 1100 may be implemented in the mobile terminal 200 or the output destination terminal 300.

The store information display system 1100 includes the information acquisition means 110, the information processing means 120, and the output means 130, similarly to a first example embodiment, and further includes the storage means 140. In FIG. 3, each block included in the store information display system 1100 indicates a configuration of a functional unit. Therefore, each block included in the store information display system 1100 illustrated in FIG. 3 may be implemented in a single device, or may be separately implemented in a plurality of devices.

The information acquisition means 110 acquires the identification information and the location information from the mobile terminal 200. The identification information is information that can identify at least one of the user of the mobile terminal 200 and the mobile terminal 200. Examples of the information that can identify the user of the mobile terminal 200 include an identification (ID) set in advance for each user of the mobile terminal 200, a user number, a user name, and the like, but are not limited thereto as long as the information can identify the user of the mobile terminal 200. Examples of the information that can identify the mobile terminal 200 include a terminal number, a serial number, and the like unique to each mobile terminal 200, but are not limited thereto as long as the information can identify the mobile terminal 200.

In a case where the identification information is information that can identify the user of the mobile terminal 200, the user of the mobile terminal 200 can be directly identified. In addition, in a case where the identification information is information that can identify the mobile terminal 200, the user of the mobile terminal 200 can be indirectly identified by identifying the mobile terminal 200. Therefore, hereinafter, the “user of the mobile terminal 200” can be read as the “mobile terminal 200”.

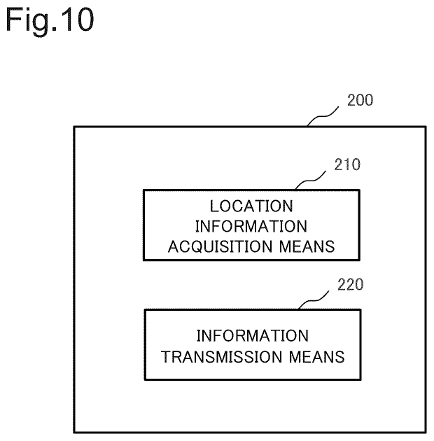

The location information is acquired by a location information acquisition means 210 (see FIG. 10) included in the mobile terminal 200. The location information acquisition means 210 will be described later.

The information processing means 120 identifies a store visited by the user of the mobile terminal 200 based on the location information of the mobile terminal 200 acquired by the information acquisition means 110. Then, the identified store, visit information regarding a visit to the identified store, and the identification information are associated with each other. Specifically, the store visited by the user of the mobile terminal 200 is identified based on whether or not the location information of the mobile terminal 200 acquired by the information acquisition means 110 matches location information of the store.

Further, when the location information of the mobile terminal 200 matches the location information of the store for a predetermined time or more, that is, when the user stays for the predetermined time or more, the store may be identified as the store visited by the user of the mobile terminal 200. In this case, when the time during which the location information of the mobile terminal 200 matches the location information of the store is equal to or less than a predetermined time, such as when the user of the mobile terminal 200 passes near the store, the store is not identified as a visit. Therefore, the store visited can be identified with higher accuracy.

The information processing means 120 may perform the identification by using additional information in addition to the location information. The additional information may be acquired by an additional information acquisition means (not illustrated) provided in the store information display system 1100, or may be acquired from an external device by the information acquisition means 110. The additional information is history information of authentication by a camera installed in the store, history information of authentication by reading a code installed in the store, and the like. In addition, when the user of the mobile terminal 200 is an employee of a company that operates a store, history information of a login to a store computer installed in a visit store or history information of an entry to an area where only an employee can enter may be used as the additional information. When the user of the mobile terminal 200 is a customer who uses the store, the history information of authentication or payment processing information at the time of entering the store may be used as the additional information.

In the case of identifying the visited store using the additional information in addition to the location information, it is possible to identify the visited store with higher accuracy. For example, in a case where there are a plurality of stores in the vicinity, it is possible to identify a visited store with high accuracy by using the additional information in addition to the location information.

The visit information is information on a visit to the store by the user of the mobile terminal 200. The visit information includes a visit date and time, a stay time, and the like, but is not limited thereto. As the visit date and time, a date and time when the location information of the mobile terminal 200 matches the location information of the store (that is, the store visit date and time) may be used as the visit date and time, and a date and time when the location information of the mobile terminal 200 does not match the location information of the store from a state in which the location information of the mobile terminal 200 matches the location information of the store (that is, the store leaving date and time) may be used as the visit date and time. As the stay time, a time during which the location information of the mobile terminal 200 matches the location information of the store may be measured, or the stay time may be obtained by subtracting the store visit date and time from the store leaving date and time.

The storage means 140 stores the identified store, the visit information regarding a visit to the identified store, and the identification information associated by the information processing means 120. The storage means 140 will be described later.

The output means 130 outputs, to the output destination terminal 300, a store list of stores stored in the storage means 140 in association with the identification information acquired from the output destination terminal 300. In this case, the store information regarding the stores stored in the storage means 140 may be acquired from a storage means (not illustrated) different from the storage means 140 and output to the output destination terminal 300. The acquisition of the identification information from the output destination terminal 300 may be acquired by the information acquisition means 110 or may be acquired by a second information acquisition means (not illustrated) different from the information acquisition means 110.

The store list output by the output means 130 is generated based on the identification information and the history information including the visit information. Here, the history information is a set of visit information including at least one or more pieces of visit information. Specific examples of the store list output by the output means 130 will be described below with reference to the drawings.

### Specific Example 1 of Store List

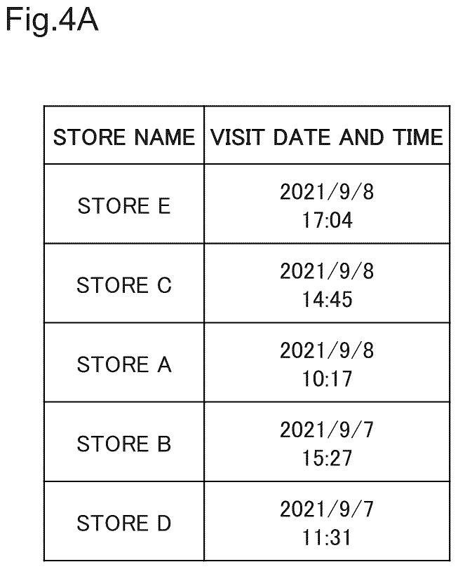

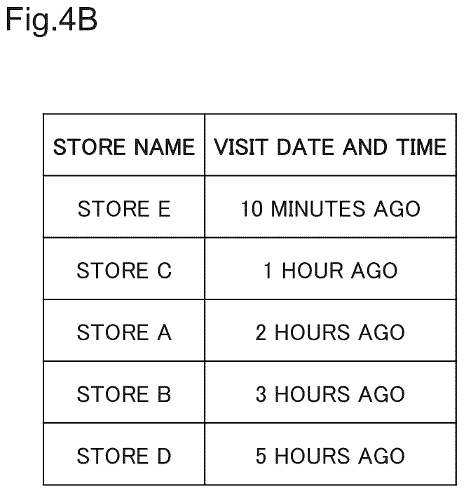

The output means 130 outputs a store list generated based on visit dates and times. FIGS. 4A and 4B illustrate examples of a store list based on visit dates and times. In FIGS. 4, store information is displayed in order from the latest visit based on the visit dates and times. In FIG. 4A, as an example, store names are displayed as store information, and dates and times of visits to the stores are also displayed. However, the visit dates and times may not be displayed. In FIG. 4B, how long ago the times of visits to each store were from the current time is displayed together with store names.

Since there is a high possibility that a store visited by the user of the mobile terminal 200 is a store from which the user of the output destination terminal 300 wants to acquire store information, in a case where the store list in the order in which the user of the mobile terminal 200 visits is output based on the visit dates and times, the system user can easily acquire desired store information.

### Specific Example 2 of Store List

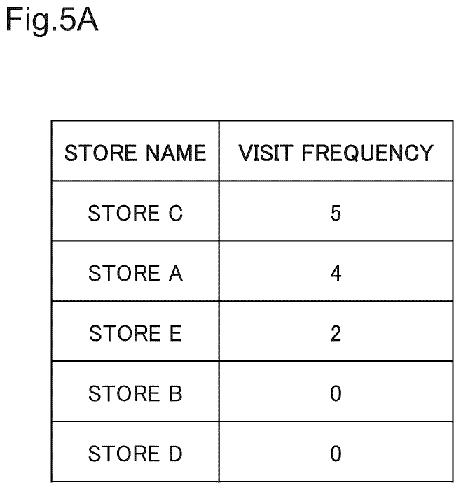

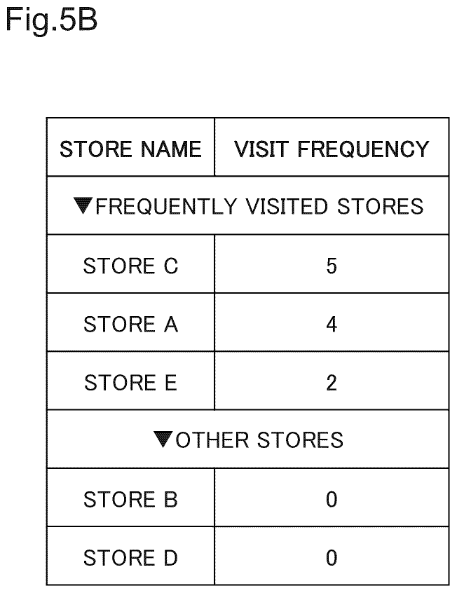

The output means 130 calculates a visit frequency from the history information, and outputs a store list generated based on the visit frequency. However, the visit frequency may be calculated by the information processing means 120 or the output means 130, or may be calculated by a calculation means (not illustrated). FIGS. 5A and 5B illustrate examples of a store list based on visit frequencies. In FIGS. 5A and 5B, store information is displayed in descending order of visit frequency based on the visit frequencies. In FIGS. 5, as an example, store names are displayed as the store information, and the visit frequency of each store is also displayed. However, the visit frequencies may not be displayed.

Each of the visit frequencies may be the number of visits within a designated period. In addition, the number of visits may be obtained from all the visit information stored in the storage means 140, and the sum thereof may be used as the visit frequency. In a case where a period is designated for calculation of a visit frequency, a method of designating a year and a month such as the latest one month or September 2021, a method of designating a year, a month, and a week such as the latest one week or the second week of September 2021, a method of designating a period by dates such as Sep. 1, 2021 to Sep. 7, 2021, and the like can be considered. In addition, the period may be designated in advance, and the period may be arbitrarily designated by the user of the output destination terminal 300.

In FIG. 5A, stores are displayed in descending order of visit frequency, and stores with high visit frequencies are displayed at high ranks. In FIG. 5A, store information of stores that have not been visited is also displayed, but the store information of the stores that have not been visited may not be displayed. In a case where the store information of the stores that have not been visited is not displayed, only store information including visit information is displayed, so that store information desired to be acquired can be easily acquired. On the other hand, as illustrated in FIG. 5A, in a case where store information of a store that has not been visited is also displayed, it is possible to cope with a case where the user of the mobile terminal 200 desires to acquire the store information of the store that has not been visited. The order in which the store information regarding the stores that have not been visited may be any order such as Japanese syllabary order or alphabetical order. In addition, as the order in which the store information regarding the stores that have not been visited is displayed, the location information of the output destination terminal 300 may be acquired from a location information acquisition means (not illustrated) included in the output destination terminal 300, and the store information may be displayed in order of proximity from the position of the output destination terminal 300. In addition, the order in which the store information regarding the stores that have not been visited may be changed based on a positional relationship with a store with a high visit frequency.

In FIG. 5B, stores having a visit frequency equal to or higher than a predetermined value are grouped as “frequently visited stores”, and stores having a visit frequency less than the predetermined value are grouped as “other stores”. FIG. 5B illustrates an example in which the predetermined value is “1”, but an arbitrary value may be set as the predetermined value. Alternatively, a plurality of predetermined values may be set, and the stores may be grouped into three or more groups and displayed. As an example of grouping into three or more groups, it is conceivable that a first predetermined value is “5”, a second predetermined value is “1”, stores having a visit frequency equal to or higher than the first predetermined value are grouped as “frequently visited stores”, stores having a visit frequency less than the first predetermined value and equal to or higher than the second predetermined value are grouped as “occasionally visited stores”, and stores having a visit frequency less than the second predetermined value are grouped as “other stores”.

As another method of grouping illustrated in FIG. 5B, a method of grouping a predetermined number of stores with high visit frequencies as “frequently visited stores” and other stores as “other stores” is also considered. In this case, since the number of stores displayed in the group of “frequently visited stores” is kept constant, it is possible to prevent the number of stores displayed in the group of “frequently visited stores” from increasing.

Further, in FIG. 5B, whether or not to display the store information for each group may be switchable. For example, store information of “store B” and “store D” may be hidden by selecting a field of “other stores” in FIG. 5B, and the store information of “store B” and “store D” may be displayed by selecting the field of “other stores” again. In this way, it is possible to hide a group not including store information desired to be acquired by the user of the output destination terminal 300, and it is easier to acquire the desired store information.

A store having a high visit frequency is likely to be a store of which store information is desired to be acquired by the user of the output destination terminal 300. Therefore, in a case where the store list in descending order of visit frequency of the user of the mobile terminal 200 based on the visit frequency is output, the system user can easily acquire desired store information.

### Specific Example 3 of Store List

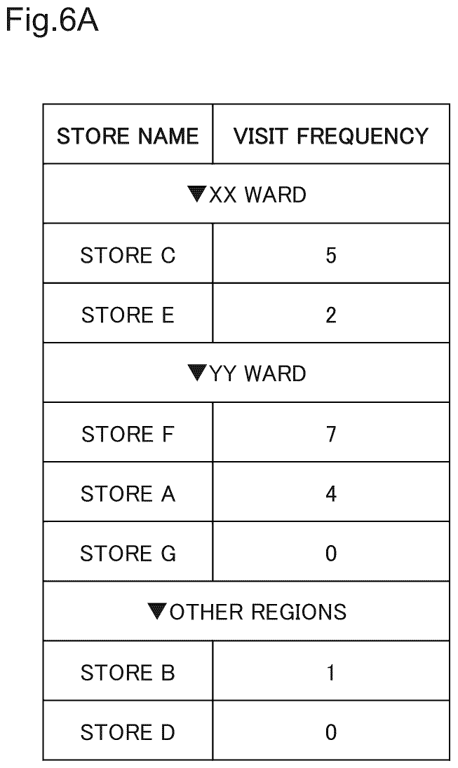

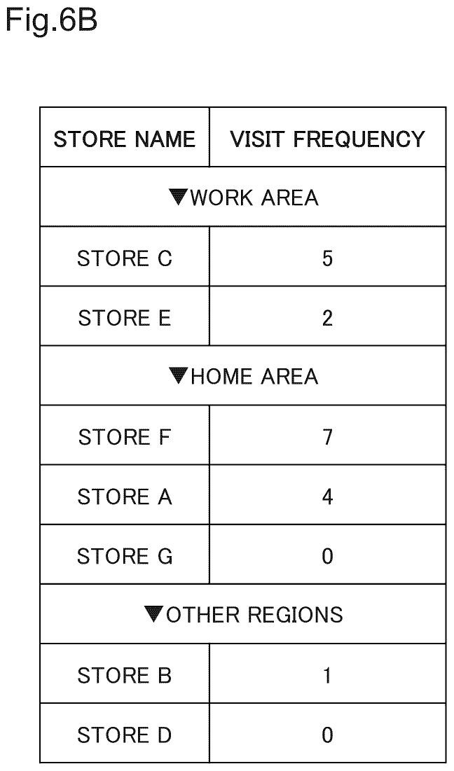

The output means 130 calculates a visit frequency from the history information, and outputs a store list generated based on the visit frequency and location information of a store. However, the visit frequency may be calculated by the information processing means 120 or the output means 130, or may be calculated by a calculation means (not illustrated). FIG. 6 illustrate examples of a store list based on visit frequencies and location information of stores. In FIGS. 6, the display of the store information is grouped based on the location information of the stores, and the store information is displayed in descending order of visit frequency among groups. In FIGS. 6A and 6B, as an example, store names are displayed as the store information, and the visit frequency of each store is also displayed. However, the visit frequencies may not be displayed.

In FIG. 6A, stores are grouped into groups such as “XX ward” and “YY ward” for each of locations of the stores, and store information is displayed in order from a store having the highest visit frequency among the groups. As illustrated in FIG. 6A, store information that the user has never visited may also be displayed. The order of displaying stores that have not been visited is the same as that described in specific example 2 of the store list.

In addition, groups to be displayed may be settable. For example, in FIG. 6A, “ward XX” and “ward YY” are set as groups to be displayed, and store information included in other groups is collectively displayed as “other regions” in one group. In this way, the user of the output destination terminal 300 can display the groups of regions in which many stores whose store information is desired to be acquired are located, and the system user can easily acquire the desired store information.

On the other hand, in FIG. 6B, stores are grouped into groups such as “work area” and “home area”. Since “work area” and “home area” are different areas depending on the user of the output destination terminal 300, it is necessary to set them according to the user of the output destination terminal 300. A region to be set according to the user of the output destination terminal 300 is hereinafter referred to as a user setting region. The user setting region may be set within a predetermined distance from the work place or the home as the user setting region. The work place and the home may be set by inputting an address or selecting from a map. In addition, the work place and the home may be identified using location information obtained from the location information acquisition means 210 included in the mobile terminal 200, and a predetermined distance or less from the identified work place or home may be set as the user setting region. In addition, a range to be the user setting region may be set from the map.

In a case where grouping is performed based on the user setting region and stores are displayed in order from a store having the highest visit frequency in each group, a group suitable for each user of the output destination terminal 300 can be set, and a store list in a display order based on visit frequencies among the groups is output. Therefore, a display form suitable for each user of the output destination terminal 300 can be obtained, and the system user can easily acquire desired store information.

### Specific Example 4 of Store List

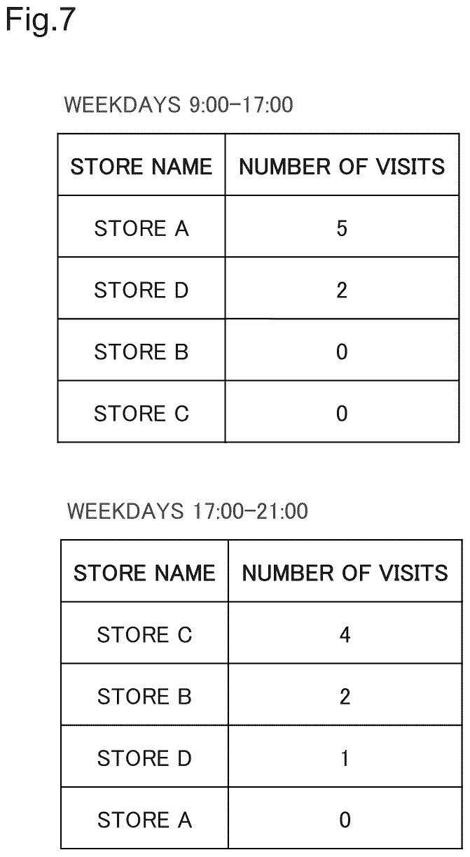

The output means 130 calculates a visit frequency from the history information, and outputs a store list generated based on the visit frequency and a visit date and time. However, the visit frequency may be calculated by the information processing means 120 or the output means 130, or may be calculated by a calculation means (not illustrated). FIG. 7 illustrates an example of a store list based on visit frequencies and visit dates and times. In FIG. 7, store information is displayed in descending order of visit frequency for each visit time zone. In FIG. 7, as an example, store names are displayed as the store information, and the visit frequency of each store is also displayed. However, the visit frequencies may not be displayed.

How to divide the time zones can be arbitrarily set. For example, it is possible to perform a setting for grouping the stores by weekdays and holidays, a setting for grouping the stores by day of a week, a setting for grouping the stores by month, year, or the like. In addition, it is also possible to perform a setting such that the stores are grouped by weekdays and holidays, and then further grouped by time. In FIG. 7, as an example, the store information is displayed in descending order of visit frequency for each time zone of “weekday 9:00-17:00” and “weekday 17:00-21:00”.

In a case where the store information is displayed in descending order of visit frequency for each visit time zone, it is possible to cope with a case where the living area of the user of the output destination terminal 300 changes depending on the time zone. For example, it is conceivable that a main living area of the user of the output destination terminal 300 is his/her work place or school place during the day, and is his/her home area at night. In such a case, by outputting a store list generated based on visit frequencies and visit dates and times, the system user can easily acquire desired store information.

Although the specific examples of the store list output by the output means 130 have been described above, the store list output by the output means 130 is not limited thereto. In the above specific examples, the store information is displayed in a table format, and the display order is changed. In addition, it is also conceivable that the order in which the store information is displayed is fixed and the display form is changed based on the history information. Examples of the change of the display form include, but are not limited to, a change of a font, a change of a background color, addition of a symbol, and a change of highlight display or size of a display frame or a display button of store information. In addition, the above-described specific examples may be combined. Further, the store list output by the output means 130 may be a part of the entire store list.

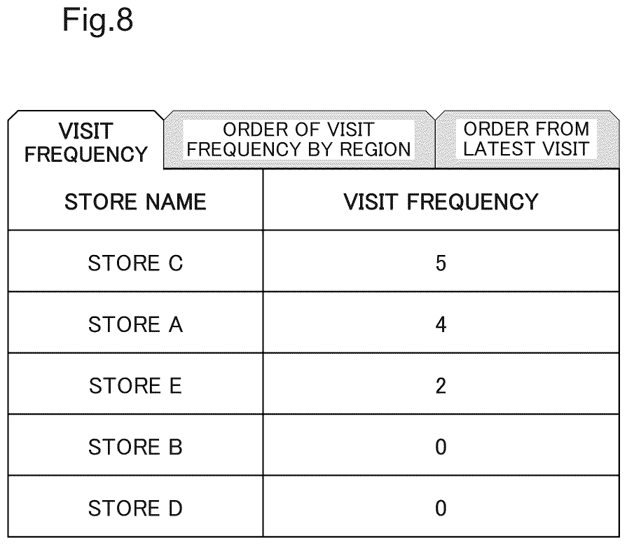

The plurality of specific examples of the store list output by the output means 130 may be switchably displayed. FIG. 8 is an example of switchably displaying a plurality of store lists. FIG. 8 illustrates an example in which a display switched between “visit frequency”, “visit frequency by region”, and “order of most recent visit” is displayed in a selectable manner.

Further, when a store is selected from the store list output to the output destination terminal 300 by the user of the output destination terminal 300, more detailed store information regarding the selected store may be displayed. When the user of the output destination terminal 300 is an employee of a company that operates a store, information regarding the store operation may be displayed as more detailed store information. Examples of the information regarding the store operation include stock information, sales information, order information, product sales price information, in-store work information, and store facility information of the store, but are not limited thereto as long as the information is information regarding the store operation. In addition, in a case where the user of the output destination terminal 300 is a customer who uses a store, coupon information, sale information, flier information, sales information, facility information, and the like may be displayed as more detailed store information.

In the specific examples of the store list output by the output means 130 described above, the store names are displayed as the store information, but coupon information may be displayed in a list as another example of the store information to be displayed. That is, the coupon list may be output instead of the store list. In particular, in a case where the user of the output destination terminal 300 is a customer who uses a store, convenience is improved by generating the coupon list based on the history information. As an example, by preferentially displaying a coupon of a store having a high visit frequency, display suitable for the user of the output destination terminal 300 is obtained, and the system user can easily acquire a desired coupon.

Furthermore, the user of the output destination terminal 300 may have a function capable of creating a list (My List) for each user of the output destination terminal 300 for a store for which the user himself/herself frequently needs to acquire store information. In this case, by using the system of the present invention, it is easy to find a store to be registered in the My List, and it is easy to select the store.

For example, in a case where the user of the output destination terminal 300 is an employee of a company that operates a store, it is conceivable to register the store that the user is in charge of in the My List. In this case, by outputting a store list generated based on the history information, store information to be registered in the My List can be easily found. Similarly, in a case where the user of the output destination terminal 300 is a customer who uses a store, it is conceivable to register a frequently visited store in the My List. Also in this case, by outputting a store list generated based on the history information, store information to be registered in the My List can be easily found.

In addition, the registration to the My List and deletion from the My List may be automatically performed based on the history information. In a case where the registration to the My List is automatically performed, it is conceivable to register a store whose visit frequency is equal to or higher than a predetermined value in the My List. In a case where deletion from the My List is automatically performed, it is conceivable to delete a store whose visit frequency is equal to or less than a predetermined value from the My List.

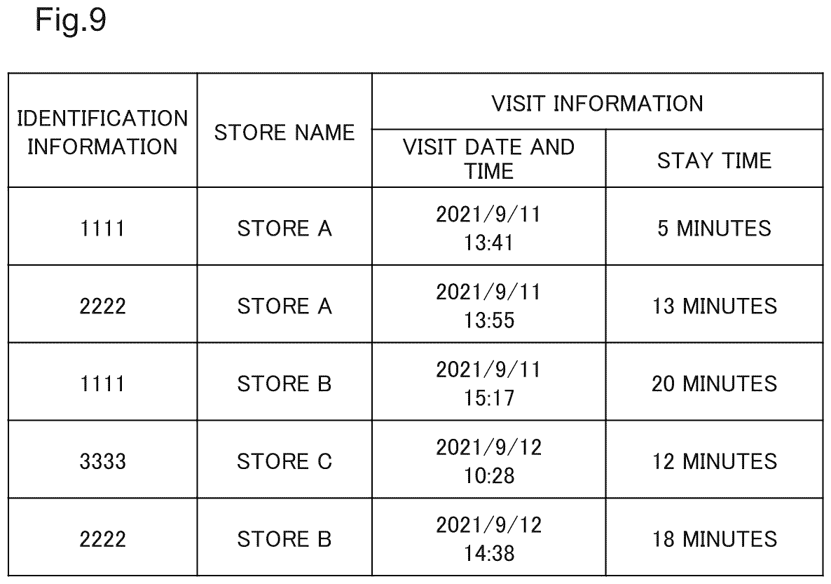

The storage means 140 stores an identified store, visit information regarding a visit to the identified store, and the identification information associated by the information processing means 120. FIG. 9 is a data sheet illustrating an example of information stored in the storage means 140. Here, the history information is a set of visit information including at least one or more pieces of visit information. That is, the data sheet illustrated in FIG. 9 can be rephrased as an example of the history information.

Referring to FIG. 9, for example, the user of the mobile terminal 200 identified by identification information “1111” visits store A at 13:41 on Sep. 11, 2021 and stays for 5 minutes, and visits store B at 15:17 on Sep. 11, 2021 and stays for 20 minutes.

In FIG. 9, the identification information, the identified store, and the visit information are stored in the storage means 140, but the information stored in the storage means 140 is not limited thereto. For example, in addition to the information illustrated in FIG. 9, store information other than the store name regarding the identified store may be further stored. In a case where the user of the output destination terminal 300 is an employee of a company that operates a store, information regarding the store operation may be included as the store information. Examples of the information regarding the store operation include stock information, sales information, order information, product sales price information, in-store work information, and store facility information of the store, but are not limited thereto as long as the information is information regarding the store operation. In addition, in a case where the user of the output destination terminal 300 is a customer who uses a store, coupon information, sale information, flier information, sales information, facility information, and the like may be included as the store information.

In a case where store information other than the store name regarding the identified store is further included as the information stored in the storage means 140, the store information may be a plurality of pieces of information. Furthermore, the store information regarding the identified store stored in the storage means 140 may be acquired from a storage means (not illustrated) different from the storage means 140. As an example, the store name of the identified store may be stored in the storage means 140, and store information regarding the identified store may be acquired from another server using the store name as a query. In addition, a store code capable of identifying the identified store may be stored in the storage means 140, and store information regarding the identified store may be acquired from another server using the store code.

Next, the mobile terminal 200 will be described with reference to FIG. 10. FIG. 10 is a block diagram illustrating an example of a configuration of the mobile terminal 200. The mobile terminal 200 includes a location information acquisition means 210 and an information transmission means 220.

The location information acquisition means 210 acquires location information of the mobile terminal 200. The location information acquisition means 210 acquires the location information using a global positioning system (GPS), information of an access point to a network, Bluetooth (registered trademark), ultrasonic communication, or the like.

The information transmission means 220 transmits the identification information and the location information to the information acquisition means 110. In a case where the store information display system 1100 is installed in the mobile terminal 200, the information transmission means 220 outputs the identification information and the location information to the information acquisition means 110.

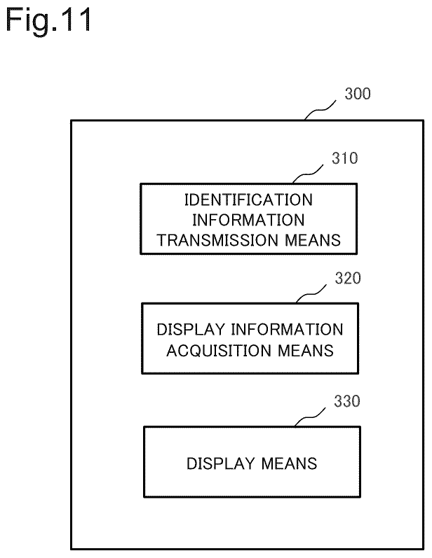

Next, the output destination terminal 300 will be described with reference to FIG. 11. FIG. 11 is a block diagram illustrating an example of a configuration of the output destination terminal 300. The output destination terminal 300 includes an identification information transmission means 310, a display information acquisition means 320, and a display means 330.

The identification information transmission means 310 transmits the identification information to the store information display system 1100. A method by which the output destination terminal 300 acquires the identification information is input by an input means (not illustrated), reading of the identification information stored in advance in a storage unit (not illustrated), or the like.

The display information acquisition means 320 acquires store information from the output means 130. The display means 330 displays the store information acquired by the display information acquisition means 320.

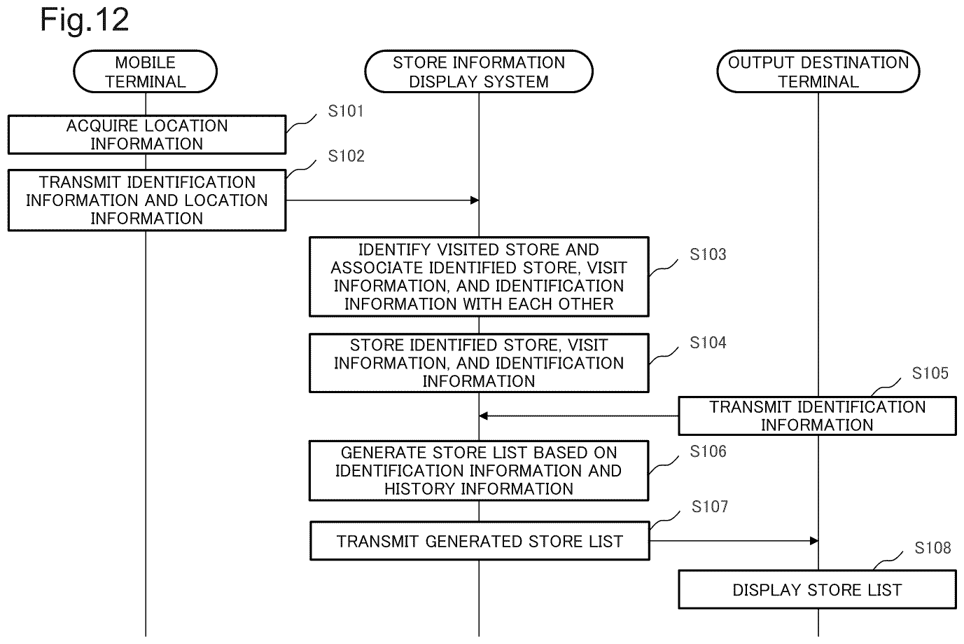

Operations of the store information display system 1100, the mobile terminal 200, and the output destination terminal 300 according to the second example embodiment will be described with reference to the drawings. FIG. 12 is a sequence diagram illustrating an example of the operations of the store information display system 1100, the mobile terminal 200, and the output destination terminal 300 according to the second example embodiment.

First, the mobile terminal 200 acquires location information by the location information acquisition means 210 (step S101). Then, the information transmission means 220 transmits the identification information and the location information to the store information display system 1100 (step S102).

When the store information display system 1100 receives the identification information and the location information, the information processing means 120 identifies a store visited by the user of the mobile terminal 200 based on the location information. Then, the identified store, visit information regarding a visit to the identified store, and the identification information are associated with each other (step S103). The storage means 140 stores the identified store, the visit information regarding the visit to the identified store, and the identification information associated by the information processing means 120 (step S104).

Steps S101 to S104 are repeatedly performed. The acquisition of the location information (step S101) and the transmission of the identification information and the location information (step S102) may be always performed, or may be performed at regular time intervals.

Next, the output destination terminal 300 transmits the identification information to the store information display system 1100 by the identification information transmission means 310 (step S105).

Upon receiving the identification information from the output destination terminal 300, the store information display system 1100 generates a store list based on the identification information received from the output destination terminal 300 and the history information including the visit information (step S106). Then, the output means 130 outputs the generated store list to the output destination terminal 300 (step S107). The history information may be an information group stored in the storage means 140 illustrated in FIG. 9, or may be an information group including the store information and the visit information associated with the identification information received from the output destination terminal 300. The store list may be generated by any of the information processing means 120, the output means 130, and the storage means 140, or may be generated by a store list generation means (not illustrated).

The output destination terminal 300 receives the store list by the display information acquisition means 320, and the display means 330 displays the acquired store list (step S108).

The store information display system according to the second example embodiment outputs the store list generated based on the identification information and the history information including the visit information of the store visited by the user of the mobile terminal 200. As a result, the system user can easily acquire desired store information.

As an example of changing the store list, in a case where a store list generated based on a visit date and time included in the history information is output, there is a high possibility that a store visited by the user of the mobile terminal 200 will be a store for which the user of the output destination terminal 300 wants to acquire store information. Therefore, the system user can easily acquire the desired store information.

As an example of changing the store list, in a case where a visit frequency is calculated from visit information included in the history information and a store list generated based on the visit frequency is output, a store with a high visit frequency is likely to be a store for which the user of the output destination terminal 300 wants to acquire store information. Therefore, the system user can easily acquire the desired store information.

As an example of changing the store list, in a case where a visit frequency is calculated from visit information included in the history information, and a store list generated based on the visit frequency and location information of a store is output, a group based on the location information of the store can be set, and the display order is changed based on the visit frequency in the group. Therefore, a display form suitable for each user of the output destination terminal 300 can be obtained, and the system user can easily acquire desired store information.

As an example of changing the store list, in a case where a visit frequency is calculated from visit information included in the history information, and a store list generated based on the visit frequency and a visit date and time is output, it is possible to cope with a case where the living area of the user of the output destination terminal 300 changes depending on the time zone. Therefore, the system user can easily acquire desired store information.

### Third Example Embodiment

A store information display system 2100 according to a third example embodiment is different from the store information display system 1100 according to the second example embodiment in further including a candidate store storage means 150. The same components as those described in the second example embodiment are denoted by the same reference signs, and the description thereof will be omitted.

The outline of the store information display system 2100 according to the third example embodiment of the present invention is similar to that in FIG. 3. However, the store information display system 2100 is different from the store information display system 1100 according to the second example embodiment in further including the candidate store storage means 150.

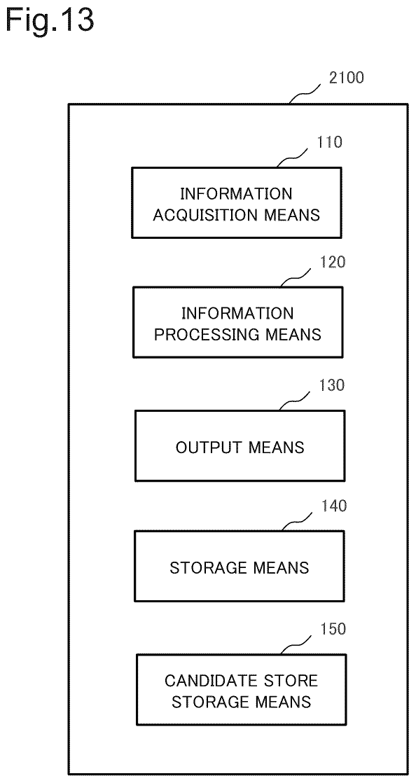

The store information display system 2100 according to the third example embodiment will be described. FIG. 13 is a block diagram illustrating an example of a configuration of the store information display system 2100 according to the third example embodiment. The store information display system 2100 includes the information acquisition means 110, the information processing means 120, the output means 130, the storage means 140, and the candidate store storage means 150. In FIG. 13, each block included in the store information display system 2100 illustrates a configuration of a functional unit. Therefore, each block included in the store information display system 2100 illustrated in FIG. 13 may be implemented in a single device, or may be separately implemented in a plurality of devices. Further, the candidate store storage means 150 may be the same as the storage means 140 or may be provided separately.

The candidate store storage means 150 stores information regarding a candidate store to be visited that is a candidate for a store to be visited by the user of the mobile terminal 200. Hereinafter, a store that is a candidate for a store to be visited by the user of the mobile terminal 200 is referred to as a candidate store. As the candidate store, for example, a candidate store of a specific industry type, such as a store operated by a specific company, a convenience store, a supermarket, a drug store, or a restaurant is conceivable. Information regarding the candidate store includes location information of the store. In addition, information that can identify the store, such as a store code, may be included as the information of the candidate store, instead of the location information of the store.

The information of the candidate store stored in the candidate store storage means 150 may be set in advance or may be set by the user of the mobile terminal 200 or the user of the output destination terminal 300. In addition, the setting may be performed by a system administrator. For example, in a case where the user of the mobile terminal 200 is an employee of a company that operates a store, it is conceivable that the store operated by the company to which the user of the mobile terminal 200 belongs is set in advance as a candidate store. Furthermore, in a case where the user of the mobile terminal 200 is a customer who uses a store, it is conceivable that the user of the mobile terminal 200 sets an industry type to be a candidate store. Alternatively, it is also conceivable that a store operated by a company that provides an application incorporating the store information display system of the present invention is set in advance as a candidate store. In addition, the setting of the candidate store may be appropriately performed.

In the store information display system 2100 according to the third example embodiment, the information processing means 120 identifies a store visited by the user of the mobile terminal 200 based on the location information of the mobile terminal 200 acquired by the information acquisition means 110 and the information of the candidate store.

Operations of the store information display system 2100, the mobile terminal 200, and the output destination terminal 300 according to the third example embodiment are similar to those in FIG. 12 except for the operation in step S103. In the third example embodiment, in step S103, the information processing means 120 identifies a store visited by the user of the mobile terminal 200 based on the location information and the information of the candidate store, and associates the identified store, visit information on a visit to the identified store, and the identification information with each other.

In the store information display system according to the third example embodiment, information of candidate stores is used to identify a store visited by a user of the mobile terminal 200. In this way, it is easy to identify the store visited by the user of the mobile terminal 200. The reason is that since a store that may be visited can be set as a candidate store, a store visited by the user of the mobile terminal 200 can be identified even when an error is included in the location information of the mobile terminal 200.

In addition, by setting the candidate store, it is possible to prevent acquisition of information that does not need to be stored as visit information.

As described above, in the store information display system according to the third example embodiment, it is possible to appropriately identify a store visited by the user of the mobile terminal 200 and identify visit history information of the store, and the system user can easily acquire desired store information.

### Fourth Example Embodiment

A store information display system 3100 according to a fourth example embodiment is different from the store information display system 1100 according to the second example embodiment in further including a non-output store storage means 160. The same components as those described in the second example embodiment are denoted by the same reference signs, and the description thereof will be omitted.

The outline of the store information display system 3100 according to the fourth example embodiment of the present invention is similar to that in FIG. 3. However, the store information display system 3100 is different from the store information display system 1100 according to the second example embodiment in further including the non-output store storage means 160.

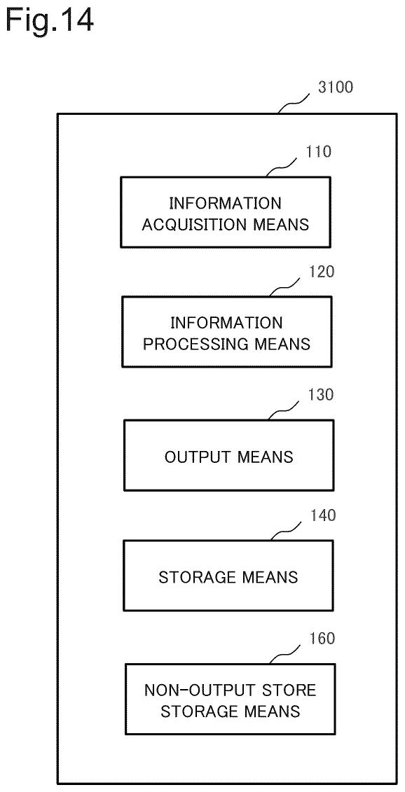

The store information display system 3100 according to the fourth example embodiment will be described. FIG. 14 is a block diagram illustrating an example of a configuration of the store information display system 3100 according to the fourth example embodiment. The store information display system 3100 includes the information acquisition means 110, the information processing means 120, the output means 130, the storage means 140, and the non-output store storage means 160. Further, the candidate store storage means 150 may be further included. In FIG. 14, each block included in the store information display system 3100 indicates a configuration of a functional unit. Therefore, each block included in the store information display system 3100 illustrated in FIG. 14 may be implemented in a single device, or may be separately implemented in a plurality of devices. In addition, the non-output store storage means 160 may be the same as the storage means 140 or may be provided separately.

The non-output store storage means 160 stores a store that does not output store information to the output destination terminal 300. In other words, the non-output store storage means 160 stores a store not included in a store list. A process of storing a store that does not output store information in the non-output store storage means 160 is hereinafter referred to as non-output setting. The non-output setting may be performed by the user of the output destination terminal 300. The non-output setting is performed, for example, based on an input to the output destination terminal 300.

The non-output setting may be automatically performed. In this case, the non-output setting may be automatically performed when a predetermined condition is satisfied. Examples of the predetermined condition include a case where a visit frequency in a predetermined period is equal to or less than a predetermined value, a case where a stay time is equal to or less than a predetermined value, and the like, but other conditions can be appropriately set. In addition, before the non-output setting is performed, an output for confirming with the user of the output destination terminal 300 whether the non-output setting may be performed may be performed.

By deleting the store stored in the non-output store storage means 160, the store information of the store can be output again. A process of deleting the store stored in the non-output store storage means 160 is hereinafter referred to as re-output setting. The re-output setting may be performed by the user of the output destination terminal 300. The re-output setting is performed, for example, based on an input to the output destination terminal 300.

The re-output setting may be automatically performed. In this case, the re-output setting may be automatically performed when a predetermined condition is satisfied. Examples of the predetermined condition include a case where a visit frequency in a predetermined period is equal to or greater than a predetermined value, a case where a predetermined time has elapsed from the non-output setting, and a case where the frequency of visits to a store present around a store set as the non-output setting is equal to or greater than a predetermined value. However, other conditions can be appropriately set. In addition, before the re-output setting is performed, an output for confirming with the user of the output destination terminal 300 whether the re-output setting may be performed may be performed. In a case where the predetermined condition is satisfied, a notification prompting the re-output setting may be performed.

The store information display system 3100 according to the fourth example embodiment generates a store list of stores other than stores stored in the non-output store storage means 160 based on the identification information and the history information including visit information, and outputs the store list to the output destination terminal 300.

Operations of the store information display system 3100, the mobile terminal 200, and the output destination terminal 300 according to the fourth example embodiment are similar to those in FIG. 12 except for an operation in step S106. In the fourth example embodiment, in step S106, the store information display system 3100 generates a store list of stores other than the stores stored in the non-output store storage means 160 based on the identification information and the history information including the visit information.

In the store information display system according to the fourth example embodiment, a store list not including the stores stored in the non-output store storage means 160 is generated. Therefore, the system user can easily acquire desired store information.

### Modification of Fourth Example Embodiment

As a modification of the fourth example embodiment, store information regarding stores stored in the non-output store storage means 160 may be included in a store list in an output form different from store information regarding stores other than the stores stored in the non-output store storage means 160.

As the output form of the store information regarding the stores stored in the non-output store storage means 160, it is conceivable that the store information is included in the store list with a lower priority than the store information regarding the stores other than the stores stored in the non-output store storage means 160. In other words, it is conceivable to display the stores stored in the non-output store storage means 160 at a low rank in the store list regardless of the history information. Furthermore, as a change in the output form, a change of a font can be considered. As the change of the font, it is conceivable to generate a store list in which the color of characters is lighter or a store list in which the character size is smaller than the display of the store information regarding the stores other than the stores stored in the non-output store storage means 160.

Operations of the store information display system 3100, the mobile terminal 200, and the output destination terminal 300 according to the modification of the fourth example embodiment are similar to those in FIG. 12 except for the operation in step S106. In the fourth example embodiment, in step S106, the store information display system 3100 generates a store list in which the output form of the store information regarding the stores stored in the non-output store storage means 160 is changed based on the identification information and the history information including the visit information.

In the store information display system according to the modification of the fourth example embodiment, the store list in which the store information regarding the stores stored in the non-output store storage means 160 is different from the store information regarding the stores other than the store stored in the non-output store storage means 160 is generated. Therefore, the system user can easily acquire desired store information.

### Fifth Example Embodiment

In a fifth example embodiment, a case where a store information display system 4100 is installed in a mobile terminal 4200 will be described. In addition, in the fifth example embodiment, the mobile terminal 4200 also operates as an output destination terminal. The same components as those described in the second example embodiment are denoted by the same reference signs, and the description thereof will be omitted.

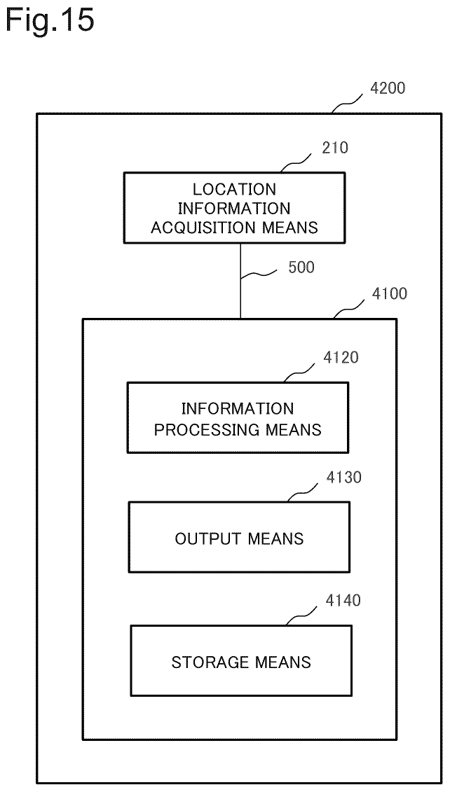

FIG. 15 is a block diagram illustrating an example of a configuration of the mobile terminal 4200 according to the fifth example embodiment of the present invention. The mobile terminal 4200 includes a location information acquisition means 210 and the store information display system 4100. The location information acquisition means 210 and the store information display system 4100 are communicably connected to each other via a bus 500. The store information display system 4100 includes an information processing means 4120, an output means 4130, and a storage means 4140. The mobile terminal 4200 may further include an input means and a display means (not illustrated). In addition, the store information display system 4100 may further include the candidate store storage means 150, and may further include the non-output store storage means 160.

In the mobile terminal 4200, location information acquired by the location information acquisition means 210 is transmitted to the store information display system 4100 via the bus. Therefore, although an information acquisition means is not illustrated in FIG. 15, it may be configured to include the information acquisition means.

The information processing means 4120 identifies a store visited by a user of the mobile terminal 4200 based on the location information of the mobile terminal 4200 acquired by the location information acquisition means 210. Then, the identified store is associated with visit information regarding a visit to the identified store.

The output means 4130 outputs a store list generated based on the history information including the visit information.

The storage means 4140 stores the store visited by the user of the mobile terminal 4200 and the visit information associated by the information processing means 4120. However, the storage means 4140 may not be included in the mobile terminal 4200.

In the fifth example embodiment, the mobile terminal 4200 also operates as an output destination terminal. Therefore, the output means 4130 instructs a display means (not illustrated) to output the store information. Alternatively, the output means 4130 may operate as a display means.

In the store information display system according to the fifth example embodiment, since the mobile terminal 4200 also operates as the output destination terminal, the user of the mobile terminal is the same as the user of the output destination terminal. Therefore, in the store information display system according to the fifth example embodiment, identification information is not necessarily required. However, the identification information may be used as necessary.

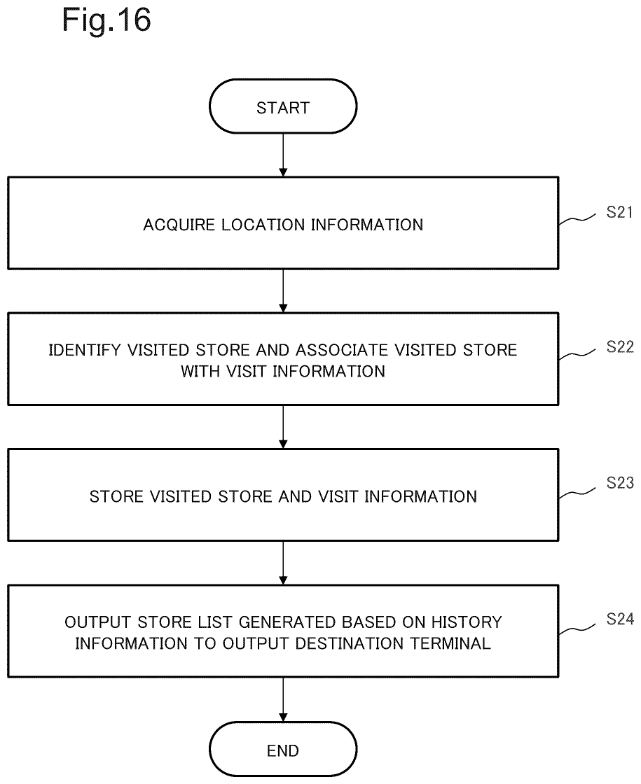

An operation of the store information display system according to the fifth example embodiment will be described with reference to the drawing. FIG. 16 is a flowchart illustrating an example of the operation of the store information display system according to the fifth example embodiment.

The location information acquisition means 210 acquires location information (step S21). Then, the information processing means 4120 identifies a store visited by the user of the mobile terminal 4200 based on the location information acquired by the location information acquisition means 210, and associates the identified store with visit information regarding a visit to the identified store (step S22). The storage means 4140 stores the store visited by the user of the mobile terminal 4200 and the visit information associated by the information processing means 4120 (step S23). Steps S21 to S23 are repeatedly performed. The acquisition of the location information (step S21) may be always performed or may be performed at regular time intervals.

The output means 4130 outputs a store list generated based on history information which is a set of visit information stored in the storage means 4140 (step S24).

The store information display system according to the fifth example embodiment outputs a store list generated based on history information including visit information of a store visited by the user of the mobile terminal 4200. As a result, the system user can easily acquire desired store information.

### Sixth Example Embodiment

A store information display system 5100 according to a sixth example embodiment is different from the store information display system 1100 according to the second example embodiment in further including a priority store storage means 170. The same components as those described in the second example embodiment are denoted by the same reference signs, and the description thereof will be omitted.

The outline of the store information display system 5100 according to the sixth example embodiment of the present invention is similar to that in FIG. 3. However, the store information display system 5100 is different from the store information display system 1100 according to the second example embodiment in further including the priority store storage means 170.

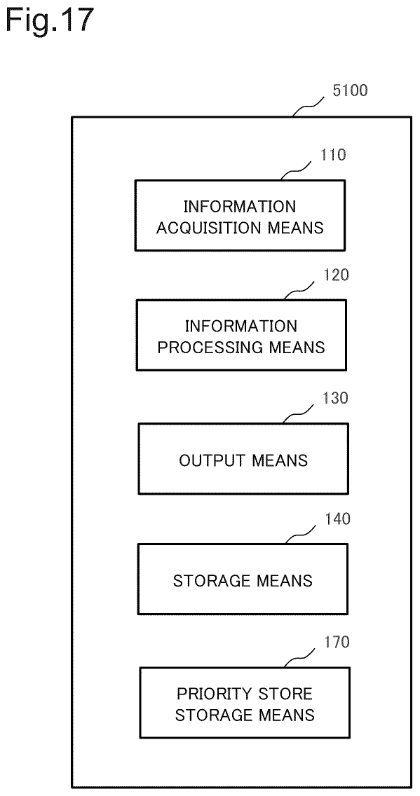

The store information display system 5100 according to the sixth example embodiment will be described. FIG. 17 is a block diagram illustrating an example of a configuration of the store information display system 5100 according to the sixth example embodiment. The store information display system 5100 includes the information acquisition means 110, the information processing means 120, the output means 130, the storage means 140, and the priority store storage means 170. In FIG. 17, each block included in the store information display system 5100 indicates a configuration of a functional unit. Therefore, each block included in the store information display system 5100 illustrated in FIG. 17 may be implemented in a single device, or may be separately implemented in a plurality of devices. In addition, the priority store storage means 170 may be the same as the storage means 140 or may be provided separately.

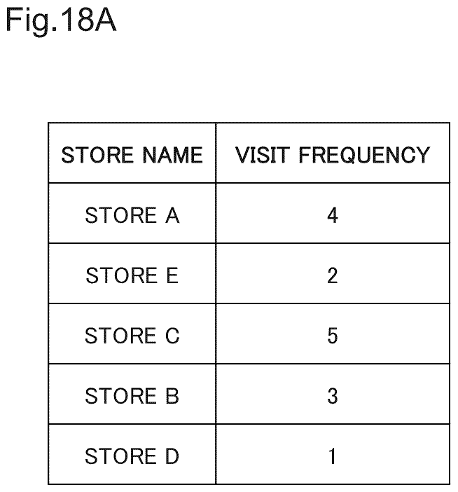

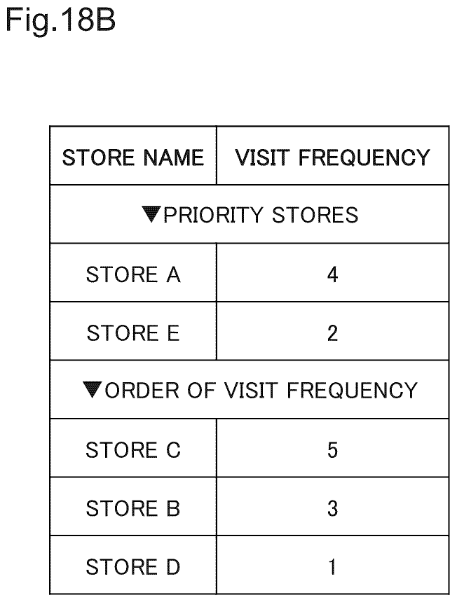

The priority store storage means 170 stores a store prioritized in a store list. Hereinafter, the store prioritized in the store list is referred to as a priority store. Here, the term “prioritized in the store list” means, for example, that the priority store is always displayed at a high rank in the store list regardless of history information, or that the store list in which specific grouping into a group such as “priority store” is performed is displayed, but is not limited thereto. FIGS. 18A and 18B are examples of a store list in a case where store A and store E are priority stores. FIG. 18A is an example of a store list in which store A and store E are displayed at high ranks in the list regardless of visit frequencies calculated from the history information. Furthermore, FIG. 18B is an example of a store list including a group of “priority stores” including store A and store E.

Here, a store list regarding stores other than the priority stores is generated based on the history information including visit information. Specifically, in FIGS. 18A and 18B, store lists regarding store B, store C, and store D, which are not priority stores, are store lists in descending order of visit frequency calculated based on the history information. The store lists illustrated in FIGS. 18A and 18B are examples, and the store lists described in <Specific Example 1 of Store List> to <Specific Example 4 of Store List> can be applied to the store lists regarding the stores other than the priority stores.

Furthermore, as another example of “prioritized in the store list”, it is also conceivable to display the priority stores and the stores other than the priority stores differently in the store list. Examples of the different display include, but are not limited to, displaying in different fonts, displaying in different background colors, providing specific symbols, and the like.

For example, it is conceivable to set a preset store or a store selected by the user of the output destination terminal 300 in the past to acquire store information as a priority store. In a case where the priority store is set in advance, the priority store may be set by the user of the mobile terminal 200 or the user of the output destination terminal 300. In addition, the setting may be performed by a system administrator. For example, in a case where the user of the output destination terminal 300 is an employee of a company that operates a store, it is conceivable that a store in which the user of the output destination terminal 300 is in charge of work regarding the store operation is set as a priority store in advance. Furthermore, in a case where the user of the output destination terminal 300 is a customer who uses a store, it is conceivable to set a store to be a priority store by the user of the output destination terminal 300.

In a case where a store selected by the user of the output destination terminal 300 in the past to acquire store information is set as a priority store, the number of stores stored in the priority store storage means 170 may be a predetermined number. Furthermore, in a case where the number of stores stored in the priority store storage means 170 exceeds the predetermined number, a store that was selected earliest by the user of the output destination terminal 300 from among the stored stores may be deleted from the priority store storage means 170, and a newly selected store may be stored. As a specific example, in a case where the number of stores stored in the priority store storage means 170 is 3, it is considered that the user of the output destination terminal 300 selects stores in the order of store A, store B, store C, and store D. In this case, when the user of the output destination terminal 300 selects store C, the priority store storage means 170 stores store A, store B, and store C. Then, when the user of the output destination terminal 300 selects store D, store A selected earliest by the user of the output destination terminal 300 is deleted from the priority store storage means 170, and store B, store C, and store D are stored in the priority store storage means 170.

In addition, in a case where a store selected by the user of the output destination terminal 300 in the past to acquire store information is set as a priority store, the priority store storage means 170 may store a store that was selected in the past more times than a predetermined number of times.

The store information display system 5100 according to the sixth example embodiment generates a store list based on history information including visit information for a store that is prioritized over a store stored in the priority store storage means 170 and is not a priority store, and outputs the store list to the output destination terminal 300.

Operations of the store information display system 5100, the mobile terminal 200, and the output destination terminal 300 according to the sixth example embodiment are similar to those in FIG. 12 except for the operation in step S106. In the sixth example embodiment, in step S106, the store information display system 5100 generates a store list based on history information including visit information for a store that is prioritized over stores stored in the priority store storage means 170 and is not a priority store.

In the store information display system according to the sixth example embodiment, the stores stored in the priority store storage means 170 are prioritized, and the store list is generated based on the history information including the visit information for stores that are not the priority stores. Therefore, the system user can easily acquire desired store information.

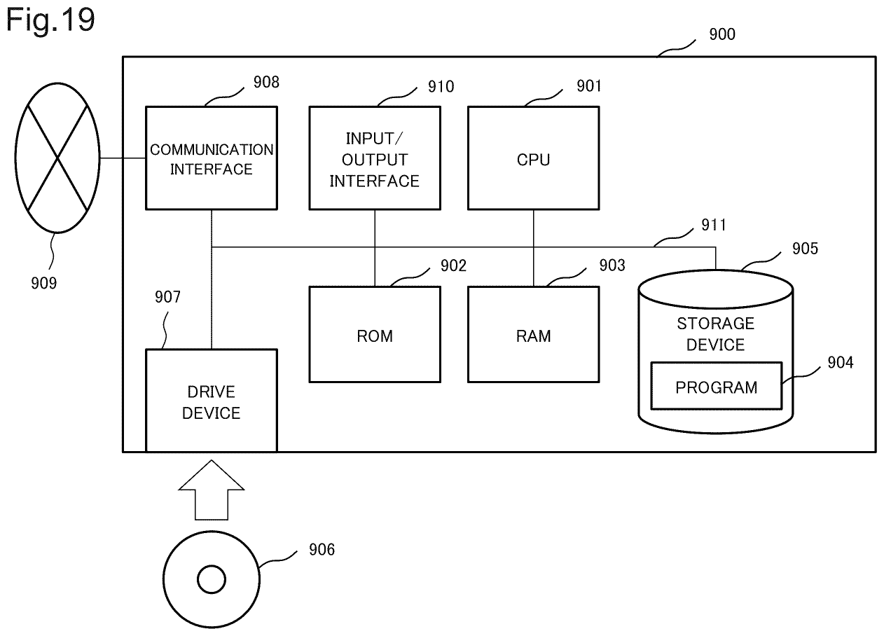

In each of the above-described example embodiments, each component of each system represents a block in units of the functions. Some or all of the components of each of the systems may be implemented by, for example, an arbitrary combination of an information processing apparatus 900 and a program as illustrated in FIG. 19. FIG. 19 is a block diagram illustrating an example of a hardware configuration of the information processing apparatus 900 that implements each component of each of the devices. The information processing apparatus 900 includes the following configuration as an example.
A central processing unit (CPU) 901
A read only memory (ROM) 902
A random access memory (RAM) 903
A program 904 to be loaded into the RAM 903
A storage device 905 storing the program 904
A drive device 907 that reads and writes data from and to a recording medium 906.
A communication interface 908 connected to a communication network 909
An Input/output interface 910 for inputting and outputting data
A bus 911 connecting each of the components

Each component of each system in each of the example embodiments is implemented by the CPU 901 acquiring and executing the program 904 for implementing these functions. That is, the CPU 901 illustrated in FIG. 19 may execute a data acquisition program and a signal schedule creation program to perform processing of updating each calculation parameter held in the RAM 903, the storage device 905, or the like. The program 904 for implementing the functions of each component of each of the devices is stored in the storage device 905 or the ROM 902 in advance, for example, and is read by the CPU 901 as necessary. The program 904 may be supplied to the CPU 901 via the communication network 909, or may be stored in advance in the recording medium 906, and the drive device 907 may read the program and supply the program to the CPU 901.

In addition, the program 904 can display the processing result including an intermediate state for each stage via a display device as necessary, or can communicate with the outside via the communication interface. Furthermore, the program 904 can be recorded on a computer-readable (non-transitory) recording medium.

The present disclosure is not limited to the above-described example embodiments, and various modifications can be made, and example embodiments obtained by appropriately combining configurations, operations, and processes disclosed in the different example embodiments are also included in the technical scope of the present disclosure.

The present disclosure is not limited to the above-described example embodiments. That is, the present invention can apply various aspects that can be understood by those skilled in the art within the scope of the present disclosure.

### [Supplementary Note 1]

A store information display system including:
an information acquisition means for acquiring, from a mobile terminal possessed by a user, identification information for identifying at least one of the user and the mobile terminal, and location information of the mobile terminal;
an information processing means for identifying a store visited by the user based on the location information, and associating the store, visit information regarding a visit to the store, and the identification information with each other; and
an output means for outputting a store list generated based on the identification information and history information including the visit information.

### [Supplementary Note 2]

The store information display system according to Supplementary Note 1, wherein the visit information includes a date and time of the visit to the store.

### [Supplementary Note 3]

The store information display system according to Supplementary Note 1 or 2, wherein the information processing means identifies the store as the visited store when the location information matches location information of the store for a predetermined time or more.

### [Supplementary Note 4]

The store information display system according to any one of Supplementary Notes 1 to 3, wherein the store is grouped in the store list.

### [Supplementary Note 5]

The store information display system according to Supplementary Note 4, wherein the store is grouped based on the history information in the store list.

### [Supplementary Note 6]

The store information display system according to Supplementary Note 4, wherein the store is grouped based on location information of the store in the store list.

### [Supplementary Note 7]

The store information display system according to any one of Supplementary Notes 1 to 6, further including
a candidate store storage means for storing candidate stores to be visited, wherein
the information processing means identifies, based on the location information, a store visited by the user from among the candidate stores to be visited.

### [Supplementary Note 8]

The store information display system according to any one of Supplementary Notes 1 to 7, further including
a non-output store storage means for storing a store not included in the store list, wherein
the store list does not include the store stored in the non-output store storage means.

### [Supplementary Note 9]

A mobile terminal possessed by a user and including:
a location information acquisition means for acquiring location information;
an information processing means for identifying a store visited by the user based on the location information, and associating the store with visit information regarding a visit to the store;
a storage means for storing the store and the visit information associated with the store; and
an output means for outputting a store list generated based on history information including the visit information.

### [Supplementary Note 10]

A store information display method including:
acquiring, from a mobile terminal possessed by a user, identification information for identifying at least one of the user and the mobile terminal, and location information of the mobile terminal;
identifying a store visited by the user based on the location information, and associating the store, visit information regarding a visit to the store, the identification information with each other; and
outputting a store list generated based on the identification information and history information including the visit information.

### [Supplementary Note 11]

A computer-readable recording medium storing a program for causing a computer to execute:
acquiring, from a mobile terminal possessed by a user, identification information for identifying at least one of the user and the mobile terminal, and location information of the mobile terminal;
identifying a store visited by the user based on the location information, and associating the store, visit information regarding a visit to the store, and the identification information with each other; and
outputting a store list generated based on the identification information and history information including the visit information.

### REFERENCE SIGNS LIST

100 store information display system
110 information acquisition means
120 information processing means
130 output means
140 storage means
150 candidate store storage means
160 non-output store storage means
200 mobile terminal
210 location information acquisition means
220 information transmission means
300 output destination terminal
310 identification information transmission means
320 display information acquisition means
330 display means
400 network
500 bus
900 information processing apparatus
901 CPU (Central Processing Unit)
902 ROM (Read Only Memory)
903 RAM (Random Access Memory)
904 program
905 storage device
906 recording medium
907 drive device
908 communication interface
909 communication network
910 Input/output interface
911 bus

What is claimed is:

1. A store information display system comprising:
at least one memory storing instructions; and
at least one processor configured to execute the instructions to:
acquire, from a mobile terminal possessed by a user, identification information for identifying at least one of the user and the mobile terminal, and location information of the mobile terminal;
identify a store visited by the user based on the location information, and associating the store, visit information regarding a visit to the store, and the identification information with each other; and
output a store list generated based on the identification information and history information including the visit information.

2. The store information display system according to claim 1, wherein the visit information includes a date and time of the visit to the store.

3. The store information display system according to claim 1, wherein the at least one processor is further configured to execute the instructions to:
identify the store as the visited store when the location information matches location information of the store for a predetermined time or more.

4. The store information display system according to claim 1, wherein the store is grouped in the store list.

5. The store information display system according to claim 4, wherein the store is grouped based on the history information in the store list.

6. The store information display system according to claim 4, wherein the store is grouped based on location information of the store in the store list.

7. The store information display system according to claim 1, the at least one processor is further configured to execute the instructions to:
store candidate stores to be visited; and
identify based on the location information, a store visited by the user from among the candidate stores to be visited.

8. (canceled)

9. A store information display method comprising:
acquiring, from a mobile terminal possessed by a user, identification information for identifying at least one of the user and the mobile terminal, and location information of the mobile terminal;
identifying a store visited by the user based on the location information, and associating the store, visit information regarding a visit to the store, and the identification information with each other; and
outputting a store list generated based on the identification information and history information including the visit information.

10. A computer-readable recording medium storing a program for causing a computer to execute:
acquiring, from a mobile terminal possessed by a user, identification information for identifying at least one of the user and the mobile terminal, and location information of the mobile terminal;
identifying a store visited by the user based on the location information, and associating the store, visit information regarding a visit to the store, and the identification information with each other; and
outputting a store list generated based on the identification information and history information including the visit information.
